(19) United States
(12) Patent Application Publication
(10) Pub. No.: US 2016/0046060 A1
(43) Pub. Date: Feb. 18, 2016

(54) APPARATUS FOR SHAPING PLASTICS MATERIAL PRE-FORMS INTO PLASTICS MATERIAL CONTAINERS

(71) Applicant: KRONES AG, Neutraubling (DE)

(72) Inventor: Klaus Voth, Neutraubling (DE)

(21) Appl. No.: 14/802,069

(22) Filed: Jul. 17, 2015

(30) Foreign Application Priority Data
Aug. 13, 2014 (DE) 10 2014 111 590.2

(51) Int. Cl. B29C 49/42; B29C 49/30

(52) U.S. Cl. CPC B29C 49/4268; B29C 49/30; B29L 2031/712

(57) ABSTRACT

In an apparatus for shaping plastics material pre-forms into plastics material containers, the blow mould comprises a first mould part and a second mould part, the blow mould comprises a base part which is movable with respect to the mould parts along a lifting direction extending parallel to the longitudinal axis of the mould parts, in order to close off a cavity, in the closed setting, in the lifting direction, and wherein a plastics material pre-form is capable of being directly acted upon with pressure by a gaseous medium inside the cavity, wherein at least one second drive device which is designed in the form of an electric linear drive is set up and provided to move the base part relative to the mould parts in the lifting direction.

### RELATED APPLICATIONS

This application claims priority to German Patent Application Serial No. DE 10 2014 111 590.2, filed Aug. 13, 2014, the content of which is incorporated herein by reference, in its entirety.

### FIELD

The present invention relates to an apparatus for shaping plastics material pre-forms into plastics material containers as well as to a method of shaping plastics material pre-forms into plastics material containers according to the respective preamble of claims 1 and 11.

### DESCRIPTION OF DRAWINGS

The apparatus described here and the method described here are explained in greater detail with reference to an embodiment and corresponding perspective views. In the drawings

FIG. 1 is a diagrammatic plan view of an embodiment of an apparatus described here for shaping plastics material pre-forms into plastics material containers;

FIG. 2 is a dragrammatic side view of an embodiment of a blow moulding module described here, and

FIGS. 3A to 3C are diagrammatic side views of various settings of a base part which is driven by means of an embodiment of an electric linear motor described here.

### DETAILED DESCRIPTION

In particular, therefore, the present invention relates to an apparatus for shaping plastics material pre-forms into plastics material containers which comprises at least one blow mould, the blow mould comprising in turn a first mould part and a second mould part. In this case the first mould part and the second mould part are movable with respect to each other between a closed setting and an opened setting by means of a first drive device, and the blow mould comprises a base part which is movable with respect to the mould parts along a lifting direction extending parallel to the longitudinal axis of the mould parts, in order to close off a cavity, in the closed setting, in the lifting direction, and a plastics material pre-form is capable of being directly acted upon with pressure by a gaseous medium inside the cavity.

An apparatus of this type for shaping plastics material pre-forms into plastics material containers, however, is well-known from the prior art.

By way of example, the publication EP 2 199 061 A1 likewise discloses an apparatus for shaping plastics material pre-forms into plastics material containers. In particular, this publication likewise discloses a drive which is used for raising or lowering a base part of the blow moulding apparatus disclosed in this publication. The drive disclosed in this publication is used, however, to implement the control of the base part by means of mechanical guide cams.

The blow moulding procedure as a whole, however, still has a plurality of further mechanical movements, for example the unlocking and locking movement of the mould carrier or the movement of the blow moulding nozzle, so that a coupling of the individual movements and the drives thereof can be used to accelerate the process sequences. This is important, in particular when a rapid change-over to different sizes of containers is necessary, which, as is known, is very complicated when mechanical guide cams are used.

In accordance with the present invention, however, the inventors have recognized, in contrast to the prior art named above, that a more rapid and inexpensive change-over of this type to different types and sizes of containers is possible if a base part is capable of being set relative to the first and the second mould part in an individual and time-saving manner.

In particular, the present invention is based in fact upon the knowledge, inter alia, that a base part of a blow moulding apparatus should always be at a preferably equal distance from a lower edge of a support ring of a plastics material pre-form to be introduced. If, for example, a smaller container, for example a smaller pre-form, is inserted into the mould, then a distance between the base part and a base of a container of this type is accordingly increased in an undesired manner. According to the prior art, and for example as an alternative to EP 2 199 961 A, this increased distance is bridged with a spacer member. Such a spacer member, however, must first be positioned separately in each case for individual sizes of containers at and/or on the base part in a complicated manner. A method of this type is therefore also very complicated.

On this basis it is therefore an object of the present invention to overcome the problems named above and, in this respect, to make available an apparatus for shaping plastics material pre-forms, which makes it possible, in an inexpensive and at the same time time-saving manner, to change a blow moulding arrangement over to other sizes of containers.

This object is attained according to the invention by an apparatus according to claim 1. Advantageous embodiments and further developments form the subject matter of the sub-claims.

In order to make available now an apparatus for shaping plastics material pre-forms, which both in an inexpensive manner and also in a time-saving manner provide a particularly individual change-over of the apparatus to different containers to be blow moulded, in particular plastics material pre-forms, the present invention inter alia makes use of the idea of using a second drive device which is designed in the form of an electric linear drive which is set up and provided in order to move the base part in the lifting direction relative to the mould parts.

In other words, the apparatus for shaping plastics material pre-forms into plastics material containers therefore comprises this second electric drive device.

It has therefore been recognized, in particular, that the use of an electric linear drive not only represents in principle a drive device designed in a particularly structurally simple manner, but that an electric linear drive of this type can also be used in a particularly reliable manner for driving the base part in the lifting direction.

In this way, a drive—differing from an electric linear drive—for the base part, for example a pneumatic (linear) drive, and/or mechanical guide cams for the movement of the base part is or are dispensed with completely. In particular, only the base part can also be driven by means of an electric drive, for example by means of the electric linear drive described here, in which case, in contrast to the second drive device, the first drive device can be one which comprises mechanical guide cams for opening and closing the mould parts.

As an alternative to this, however, it is possible in the same way for the first drive device in turn to be an electric drive in the same way as the second drive device.

A key feature of the present invention is in any case that at least the second drive device is designed in the form of the electric linear drive described above.

By means of the electric linear drive described here the base part can also in fact be raised and lowered relative to the mould parts inside or on the linear drive in a particularly simple and controlled manner by the application of electrical energy. The linear drive then in fact has in principle crucial advantages if locking of various parts with respect to one another is to be carried out in a manner free of coupling and/or gear reduction for fine adjustment.

In accordance with at least one embodiment the apparatus for shaping plastics material pre-forms into plastics material containers comprises at least one blow mould, the blow mould in turn comprising a first mould part and a second mould part, the first mould part and the second mould part being movable with respect to each other between a closed setting and an opened setting by means of a first drive device, and the blow mould comprises a base part which is movable with respect to the mould parts along a lifting direction extending parallel to the longitudinal axis of the mould parts, in order to close off a cavity, in the closed setting, in the lifting direction, and a plastics material pre-form being capable of being directly acted upon with pressure by a gaseous medium inside the cavity. The “lifting direction” is therefore a direction which is preferably parallel to a main extension direction of the two mould parts.

In accordance with at least one embodiment the second drive device comprises at least one stator positioned in a stationary manner relative to a common axis of rotation of the mould parts, and one rotor capable of being conveyed along and/or inside the stator, the base part being positioned, in particular in the form of a floating mounting, in a releasable or non-releasable manner on an end of the rotor facing the mould parts.

In the case of a “floating mounting” only an axial force is absorbed in a direction, preferably in the lifting direction, per side for example. Whereas zero clearance or pre-stressing is aimed for in the case of a conventional engaged mounting for a state of the blow mould at operating temperature, a certain degree of axial clearance about an axis parallel to the lifting direction, for example several tenths of a millimetre depending upon the size of the bearing, is consciously and intentionally accepted in the case of the floating mounting.

A narrow axial guide is therefore dispensed with in the case of this type of mounting. In this respect the axial clearance need not be set as carefully during the fitting of the base part and the application of the base part to the rotor as would be the case with an engaged mounting. The tolerances are therefore set in such a way that the bearing between the rotor and the base part is not tensioned axially even under particularly unfavourable thermal conditions (in particular rapid heating and/or cooling). In other words, a floating mounting of this type ensures that a bearing between the base part and the rotor is free of mechanical tensioning.

In accordance with at least one embodiment the rotor is movable continuously in a reciprocating manner along and/or inside the stator. In other words, the linear drive described above therefore permits not only a particularly simple, and in particular also direct and low-friction, adjustment of the base part relative to the mould parts, but in addition in at least one embodiment ensures a much more extensive fine adjustment of the base part relative to the mould parts by way of the continuous reciprocating movement capacity of the rotor.

In accordance with at least one embodiment the stator is stationary, whilst the rotor is connected directly to the base plate and is moved. In this case the stator can be arranged in a releasable or non-releasable manner on a holding means arranged so as to be stationary, in which case the holding is at least indirect, and in the same way a holding means for the second drive device. In this context “at least indirect” means that either the holding means is connected directly to the second drive device or, on the other hand, that at least one or more connecting elements are attached between the holding means and the second drive device. In this respect in the case of a direct arrangement of the second drive device on the holding means these two are also in direct contact with each other, whereas in the case of a merely indirect arrangement there is no direct contact between the holding means and the second drive device. In this case “stationary” refers to the fact that, although the holding means can be jointly conveyed along a conveying path for example, this holding means cannot be altered in its position relative to a common axis of rotation of the mould parts even during a further conveying of the holding means in this way along this conveying path.

A holding means serves to position the stator in a simple, stationary manner and, in particular, also to guide the rotor in a stable manner relative to the mould parts. During the conveying of the individual blow moulds along the conveying path the position of the base part is therefore prevented by means of the holding means from being shifted in such a way that in a closed setting of the blow mould the aforesaid base part can no longer form the cavity described above with the mould parts in a pressure-tight manner.

In accordance with at least one embodiment at least one conveying element is arranged adjacent to the rotor so as to be movable in a manner displaceable in the lifting direction or is arranged along the holding means, in which case the conveying element is, in particular, only a guide for guiding along the base part in the lifting direction. In other words, the guiding element described here is not used for driving the base part, but only for a movement of the base part guided in its direction relative to the two mould parts. In particular, the guiding element can be free of an engagement of a drive device. This can mean that the guiding element described here forms at least part of a sliding bearing. In other words, therefore, according to the present invention only the rotor is driven electrically by means of the electric linear motor described here.

In accordance with at least one embodiment the base part is additionally positioned in a releasable or non-releasable manner, in particular in the form of a floating mounting, on an end of the guiding element facing the mould parts. In this case it is possible for the base part therefore to be mounted separately in each case by means of a floating mounting both on the rotor and on the guiding element.

Furthermore, it is possible for the apparatus for shaping to comprise at least two guiding elements of this type, which can be arranged in the lateral direction, i.e. in a direction at a right angle to the lifting direction on both sides of the stator or the rotor.

In accordance with at least one embodiment the rotor and/or the guiding element is or are designed in the form of a rod, in which case at least the guiding element is capable of being guided completely through the holding means in the lifting direction.

In accordance with at least one embodiment a control of the base part is operated in a manner dependent upon a control of the mould parts. In this respect the apparatus described here for shaping plastics material pre-forms into plastics material containers can comprise at least one separate control means of the base part as well as a separate control of the mould parts, the two control means being in data communication with each other by means of a controller unit for example. In this respect, therefore, both a closing movement and, on the other hand, an opening movement of the mould parts can take place in synchronism in terms of movement with the movement of the base part in the lifting direction.

As an alternative to this, however, it is also possible for the control means for the base part and the control means of the mould parts to control the individual movements in a user-defined manner and independently of each other in each case.

In a further embodiment the control of the base lift can also be taken over by the control means of the blow moulding station, as a result of which the apparatus manages with a single control means per blow moulding station, in order to be able to control both the mould parts and the base part.

In particular, one control unit for controlling the base part can be provided per blow moulding station.

In accordance with at least one embodiment the apparatus comprises an energy storage device in which mechanical and/or electrical energy released by a movement of the base part in a direction away from the mould parts is capable of being stored at least in part and this mechanical and/or electrical energy is capable of being fed into the drive device again by the energy storage device in order to produce a lifting movement of the base part in the direction of the mould parts.

In other words, energy recycling is implemented in a particularly simple manner by means of the energy storage device described here, so that the electric linear motor need be supplied with external energy, if it is necessary at all, only with a great reduction in energy by way of the energy storage device described here.

In addition, the present invention relates to a method of shaping plastics material pre-forms into plastics material containers. In this case all the features disclosed for the apparatus described above are disclosed in the same way as features described for the method described here and vice versa.

In accordance with at least one embodiment the method—described here—of shaping plastics material pre-forms into plastics material containers comprises at least one blow mould, the blow mould in turn comprising a first mould part and a second mould part, the first mould part and the second mould part being moved from an opened state into a closed state by means of a first drive device, and the blow mould comprising a base part which is moved with respect to the mould parts along a lifting direction extending parallel to the longitudinal axis of the mould parts, in order to close off a cavity in the closed setting in the lifting direction, and a plastics material pre-form being capable of being directly acted upon with a gaseous medium inside the cavity.

According to the invention the base part is moved in this case in the lifting direction relative to the mould parts by means of at least one second drive device which is designed in the form of an electric linear motor.

In this case the method described here has the same advantageous designs and advantages as described in conjunction with the apparatus described above.

In the embodiment and the figures the same components or components acting in the same way are provided with the same references in each case. The elements illustrated should not be regarded as being true to scale, but rather individual elements can be shown exaggerated for improved understanding.

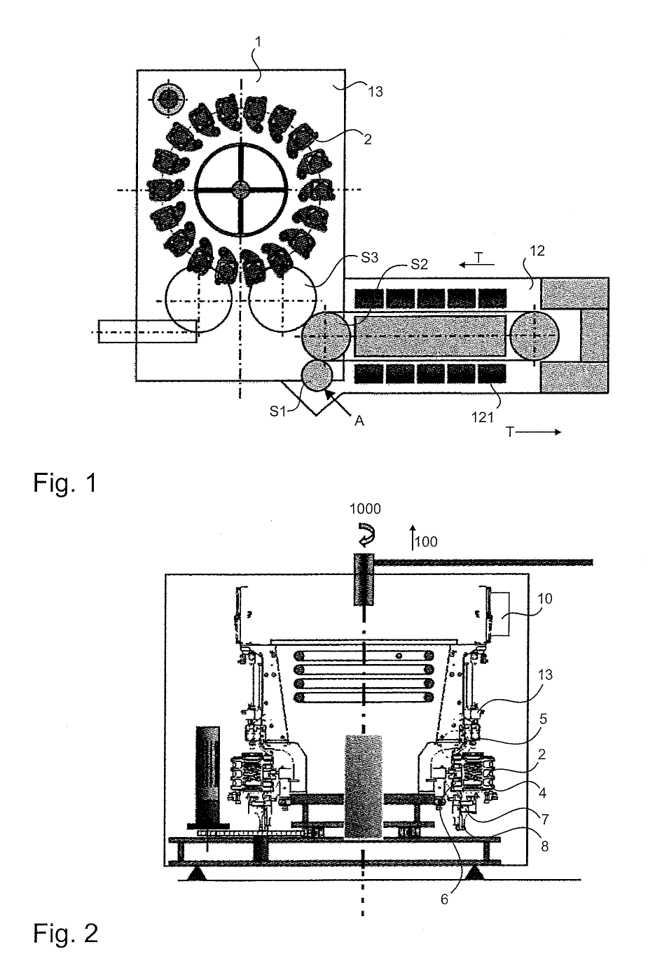

In FIG. 1 an embodiment of an apparatus 1 described here for shaping plastics material pre-forms into plastics material containers is illustrated by way of a diagrammatic plan view. As may be seen without difficulty from FIG. 1, the apparatus 1 comprises first of all a heating module 12 as well as a blow moulding module 13. First of all, therefore, plastics material pre-forms are conveyed to an entry A and they are received by a conveying star wheel S1 in order to be conveyed through heating apparatus 121.

While being conveyed through, therefore, the plastics material pre-forms are brought to a pre-heating temperature capable of being pre-set. After passing through the heating apparatus 121 in the conveying direction T, the plastics material pre-forms are thereupon transferred by way of further conveying star wheels S2, S3 to blow moulds 2 clearly allocated for example to the plastics material pre-forms in each case. In this way, the plastics material pre-forms are blow moulded into finished containers inside the blow moulds 2.

As shown in FIG. 2, the blow moulding module 13 shown in FIG. 1 is shown in a diagrammatic side view. Blow moulds 2 are shown which are arranged at the blow module 13 to the left and right of an axis of rotation 1000 and which are part of a blow moulding station in each case. It is again evident that each of the individual blow moulding stations comprises mould parts 4, 6, these mould parts 4, 6 being movable with respect to each other between a closed setting and an opened setting by means of a drive device 5. A base part 7 is movable with respect to the mould parts 4, 6 along a lifting direction 100 which extends parallel to the longitudinal axis of the mould parts 4, 6 and which is preferably parallel to the axis of rotation of the entire blow moulding station. In particular, the movement of the base part 7 in this lifting direction 100 relative to the mould parts 4, 6 is implemented by a second drive device 8, this second drive device 8 being designed according to the invention in the form of an electric linear drive.

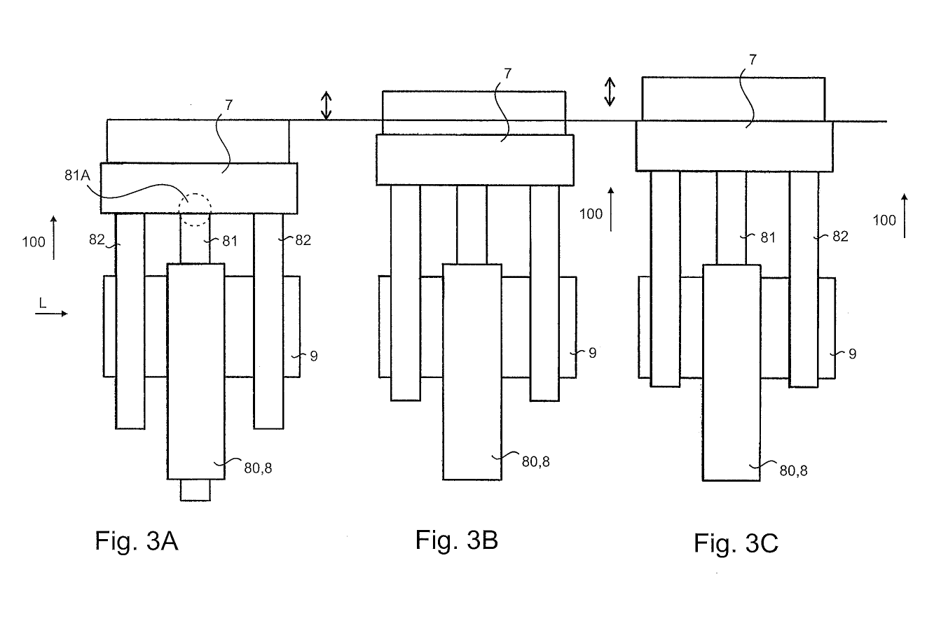

The more precise design of the second drive device 8 in the form of this electric linear drive is additionally evident from the diagrammatic side views of FIGS. 3A to 3C.

It is in fact evident that the second drive device 8 comprises a stator 80 positioned in a stationary manner relative to the common axis of rotation of the mould parts 4, 6, as well as a rotor 81 capable of being conveyed along and inside the stator 80, the base part 7 being positioned on an end 81A of the rotor which faces the mould parts 4, 6, in particular by a floating mounting. In this case the continuous sliding mounting of the rotor 81—achieved in FIGS. 3A to 3C—inside the stator 80 is achieved in that the rotor 81 is designed in the form of an element formed as a rod. The rotor 81 is in fact passed in the lifting direction 100 completely through the stator 80 which can be designed in particular in the form of a metal sleeve. A main extension direction of the stator 80 and a main extension direction of the rotor 81 are therefore parallel to the lifting direction 100 in each case. A guiding element 82, which is orientated parallel to the rotor 81, is arranged in each case on both sides of the stator 80 and thus also on both sides of the rotor 81 in the lateral direction L. In other words, a main extension direction of the guiding element 82 and a main extension direction of both the stator 80 and the rotor 81 are again parallel to each other in the same way. In addition, the two guiding elements 82 are therefore connected to the base part 7 by means of a floating mounting. A main extension direction of the base part 7 is therefore preferably at a right angle to the main extension directions of the rod-shaped elements specified above.

As may be seen without difficulty from FIG. 3A, the base part 7 there is positioned in a lower end position. Such a lower end position of the base part 7 also corresponds therefore to a completely opened blow mould 2. In other words, the mould parts 4, 6 and the base part 7 are moved completely out of one another.

A convergence of the base part 7 in the direction of the two mould parts 4, 6 already starts, however, in FIG. 3B, so that the base part 7 is already lifted in the lifting direction 100 in FIG. 3B. Accordingly, it is likewise also evident that both the rotor 81 and the two guiding elements 82, which are arranged inside a holding means 9 in each case, lift in the direction of the lifting movement 100 and are also guided in the lifting direction 100 by the holding means 9 itself, so that an upper end position can readily be achieved by such a sliding bearing both of the rotor 81 and of the two guiding elements 82. In the upper end position (see FIG. 3C), therefore, the base part 7 and the mould parts 4, 6 brought together form an air-tight cavity inside which a plastics material pre-form inserted beforehand can be blow moulded to form a container.

The invention is not restricted only by the description with reference to the embodiment. In fact the invention comprises any novel feature and any combination of features, which in particular includes any combination of features in the claims, even if this feature or this combination itself is not indicated explicitly in the claims or in the embodiment.

What is claimed is:

1. An apparatus for shaping plastics material pre-forms into plastics material containers, with at least one blow mould, wherein the blow mould comprises a first mould part and a second mould part, wherein the first mould part and the second mould part are movable with respect to each other between a closed setting and an opened setting by means of a first drive device, and wherein the blow mould comprises a base part which is movable with respect to the mould parts along a lifting direction extending parallel to the longitudinal axis of the mould parts, in order to close off a cavity, in the closed setting, in the lifting direction, and wherein a plastics material pre-form is capable of being directly acted upon with pressure by a gaseous medium inside the cavity, wherein at least one second drive device which is designed in the form of an electric linear drive and which is set up and provided to move the base part relative to the mould parts in the lifting direction.

2. An apparatus according to claim 1, wherein the second drive device comprises at least one stator positioned in a stationary manner relative to a common axis of rotation of the mould parts, and one rotor capable of being conveyed along and/or inside the stator, wherein the base part is positioned, in particular in the form of a floating mounting, in a releasable or non-releasable manner on an end of the rotor facing the mould parts.

3. An apparatus according to claim 2, wherein the rotor is movable continuously in a reciprocating manner along and/or inside the stator.

4. An apparatus according to claim 2, wherein the stator is stationary, whilst the rotor is connected directly to the base plate and is moved.

5. An apparatus according to claim 2, wherein at least one guiding element is arranged adjacent to the rotor so as to be movable in a displaceable manner in the lifting direction inside or along the holding means, wherein the guiding element is, in particular, only a guide for guiding along the base part in the lifting direction.

6. An apparatus according to claim 1, wherein the base part is additionally positioned in a releasable or non-releasable manner, in particular in the form of a floating mounting, on an end of the guiding element facing the mould parts.

7. An apparatus according to claim 1, wherein the guiding element is arranged laterally adjacent to the stator and/or the rotor so as to be movable in a displaceable manner in the lifting direction.

8. An apparatus according to claim 1, wherein the rotor and/or the guiding element is or are designed in the form of a rod, wherein at least the guiding element is capable of being guided completely through the holding means in the lifting direction.

9. An apparatus according to claim 1, wherein a control of the base part is operated in a manner dependent upon a control of the mould parts.

10. An apparatus according to claim 1, wherein one control unit for controlling the base part is provided per blow moulding station.

11. An apparatus according to claim 1, wherein an energy storage device in which mechanical and/or electrical energy released by a movement of the base part in a direction away from the mould parts is capable of being stored at least for a time, and this mechanical and/or electrical energy is capable of being fed into the drive device again by the energy storage device (10) in order to produce a lifting movement of the base part in the direction of the mould parts.

12. A method of shaping plastics material pre-forms into plastics material containers, with at least one blow mould, wherein the blow mould comprises a first mould part and a second mould part, wherein the first mould part and the second mould part are moved from an opened state into a closed state by means of a first drive device, and wherein the blow mould comprises a base part which is moved with respect to the mould parts along a lifting direction extending parallel to the longitudinal axis of the mould parts, in order to close off a cavity in the closed setting in the lifting direction, and wherein a plastics material pre-form is directly acted upon with pressure by a gaseous medium inside the cavity, wherein at least one second drive device which is designed in the form of an electric linear drive and which moves the base part in the lifting direction relative to the mould parts.
